(19) United States
(12) Patent Application Publication
(10) Pub. No.: US 2013/0086143 A1
(43) Pub. Date: Apr. 4, 2013

(54) Music On Video Site

(71) Applicant: Leonardo Rossetti, Dublin (IE)

(72) Inventor: Leonardo Rossetti, Dublin (IE)

(73) Assignee: GOOGLE INC., Mountain View, CA (US)

(21) Appl. No.: 13/250,187

(22) Filed: Sep. 30, 2011

(51) Int. Cl. G06F 15/16

(52) U.S. Cl. 709/203

(57) ABSTRACT

A method performed by one or more server computers includes receiving, from a client, a plurality of music titles for respective music pieces that a user has the right to listen to; determining, for one of the plurality of music titles, that a matching video stored on the server has the respective music piece for the music title as an audio component of the matching video; adding the matching video to a list of matching videos; and storing the list of matching videos on the one or more server computers so that it is accessible to a user associated with the client.

### TECHNICAL FIELD

The disclosure relates to accessing music on internet video sites.

### BACKGROUND

Many computing devices allow users to store songs in digitally encoded media files, for playback by the computing device or for transmission to and playback on another device. Examples of these devices are personal computers, tablet computers, dedicated music player devices, and mobile telephones. Users create libraries of songs that are stored on a device, for example, by purchasing the songs from on-line music stores or by copying the music from compact discs or other media. These songs then are accessible on the device and can be played on demand by the user. As an extension of this capability, these devices allow users to create lists of songs that can be executed to play a series of songs in the order they appear in the list, or in a randomized order. This is a popular feature of music playing devices, as it allows users to create different lists of music for different purposes, such as a music playlist for a party or a music playlist for jogging. Users invest significant amounts of time in developing these playlists.

Some mobile devices, such as mobile phones, have the capability to play music, but have limited storage capability. Also, it is inconvenient to transfer music from one device such as a personal computer and store it on other devices.

### SUMMARY

Disclosed herein are systems and methods for identifying and playing music on a video site.

One aspect of the embodiments taught herein is a method that is performed by one or more server computers. The method includes receiving, from a client, a plurality of music titles for respective music pieces that a user has the right to listen to; determining, for one of the plurality of music titles, that a matching video stored on the server has the respective music piece for the music title as an audio component of the matching video; adding the matching video to a list of matching videos; and storing the list of matching videos on the one or more server computers so that it is accessible to a user associated with the client.

Another aspect of the embodiments taught herein is a video server including one or more server computers. The video server includes an object store containing a plurality of videos each having an audio component; a search component that receives a plurality of music titles for respective music pieces that a user has the right to listen to and determines, for one of the plurality of music titles, that a matching video of the plurality of videos in the object store has the respective music piece for the music title as an audio component of the matching video; and a list manager that adds the matching video to a list of matching videos and stores the list of matching videos on the one or more server computers so that it is accessible to a user associated with the client.

Another aspect of the embodiments taught herein is a video server including one or more server computers. The video server includes an object store containing a plurality of videos each having an audio component; a list store; a search component that receives, from a client, a plurality of music titles for respective music pieces that a user has the right to listen to and determines, for one of the plurality of music titles, that a matching video of the plurality of videos in the object store has the respective music piece for the music title as an audio component of the matching video; and a list manager that adds the matching video to a list of matching videos, associates the list of matching videos with a user account specified by the client, and stores the list of matching videos in the list store so that it is accessible to a user associated with the user account.

### BRIEF DESCRIPTION OF THE DRAWINGS

The description herein makes reference to the accompanying drawings wherein like reference numerals refer to like parts throughout the several views, and wherein:

FIG. 1 is block diagram showing an exemplary environment for operation of a system for indentifying and playing music on a video site;

FIG. 2 is a flow chart showing an exemplary process for indentifying and playing music on a video site; and

FIG. 3 is a block diagram showing an exemplary computer system.

### DETAILED DESCRIPTION

Publicly available, internet connected video sites have vast libraries of videos with music content. These sites are legally accessible by the public through the internet. Users of the internet are able to access the libraries on these sites and listen to the music by having the music streamed to an internet connected device. However, there is no facility for identifying videos corresponding to user libraries and playlists to allow more convenient access to the music available on these publicly available, internet connected video sites.

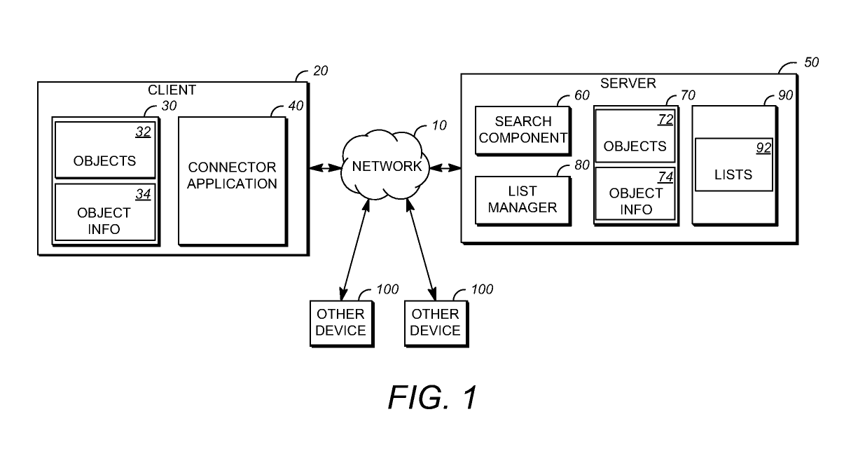

FIG. 1 shows a client 20, a server 50, and one or more other devices 100 that are all connected for transmission of data, signals, and other electrical communications with one another by a network 10, such as the internet. The client 20 and the one or more other devices 100 are related to each other in that they are controlled by a common user and/or used to access a single user account that is maintained by the server 50. For example, the client 20 can be a personal computer that is utilized by the user, and the other devices 100 could include an internet connected mobile telephone that is utilized by the user. In addition to servicing the user that is associated with the client 20 and the other devices 100, the server 50 also services a large number of other, distributed users, each of which is associated with an additional client that is analogous to the client 20 and optionally with one or more other devices that are analogous to the other devices 100.

The client 20 includes a client side object store 30. The client side object store 30 is a computer-readable media that is operable to store data in a form that can be accessed and used by the client 20. The client side object store 30 can be a conventional storage device, such as a hard disk drive, an optical disk, a floppy disk, a memory card, or any other suitable type of storage now known or later developed.

The client side object store 30 contains a plurality of client side objects 32 and object information 34 that relates to the client side objects 32. The object information 34 can be encoded within each of the client side objects 32, such that each client side object 32 contains the object information 34 corresponding to the music piece encoded in it, or the object information 34 could be encoded separately from the client side objects 32.

The client side objects 32 are music pieces that are encoded in a computer interpretable format. As used herein, “music piece” refers to an audio recording of definite length, analogous to an audio track. A music piece can correspond to a single musical composition. However, the term “music piece” can encompass works other than musical compositions, such as an audio book or a portion of an audio book.

The music pieces that are encoded as the client side objects 32 can be music pieces that the user has the right to listen to, for example, on a music service, by possession of a license to listen to the music pieces, or by virtue of the public domain status of the music pieces. The user's right to listen to the respective music pieces can derive from content licenses that are associated with the client 20. The content licenses can be computer readable documents that are stored in the client side object store 30 in association with the client side objects 32.

One well-known format by which music pieces can be encoded in a computer interpretable format is the MPEG-1 or MPEG-2 Audio Layer III format, which is commonly referred to as MP3 format. Other audio encoding formats, public or proprietary, now known or later developed can be utilized as a basis for encoding the music titles as the client side objects 32.

The object information 34 is metadata that describes one or more characteristics of the client side objects 32. The object information 34 can be stored in a metadata container that is a portion of each client side object 32. One example of storage of the object information 34 within each client side object 32 is an ID3 format tag, which is commonly appended to MP3 format media files. As an alternative, the object information 34 can be in the form of one or more files that are stored separately from the client side objects 32 in the client side object store 30. One example of separate storage of the object information 34 separate from the client side objects 32 is an index file that contains the object information 34 for some or all of the client side objects 32. An XML format file can be used for this purpose. Another example of an index file in which the object information 34 can be stored is a playlist file that identifies a plurality of the client side objects 32, such as by file name or music title, and also specifies a play order for the client side objects 32. One example of a playlist file format that can be used to encode the object information 34 is an M3U format playlist file.

The object information 34 includes music titles for one or more of the music pieces that are encoded as the client side objects 32. In addition to the music title, the object information 34 can optionally include additional information such as the artist, album, and track number for the music pieces that are encoded as the client side objects 32.

As used herein, the term “music title” refers to a title that is used to identify a respective music piece, such as the title of an individual track of an album. A music title need not, however, be unique to that music piece. On the contrary, a music title that identifies one of the client side objects 32 could also identify other music pieces. These other music pieces could be alternative versions of musical composition or other work on which the music piece is based, or could be otherwise unrelated works that coincidentally have the same music title.

The client 20 also includes a connector application 40 that is operable to send the object information 34 to the server 50. The connector application 40 can be an executable software program that is resident on the client 20. For example, the connector application can compile the object information 34 from various sources on the client, such as from the client side objects 32 themselves or from the object information 34 in the form of an index file, and upload the object information 34 to the server, either in response to a user request, or as a scheduled task that executes periodically. As an alternative, the connector application 40 can be a web application that is provided to the client 20 by the server 50, using web browser software that is resident on and executed by the client. The web application either scans the client side object store 30 to compile the object information 42, or alternatively, is pointed to a specific file, such as an index or a playlist file that contains the object information 34, by the user.

The server 50 includes a search component 60, a server side object store 70, a list manager 80, and a list store 90. The server side object store 70 and the list store 90 are storage devices or portions of storage devices. A single physical storage device can include both the server side object store 70 and the list store 90. Any suitable storage device can be utilized, as described in connection with the client side object store 30.

The search component 60 and the list manager 80 can be implemented in the form of executable software programs or functions that are resident on the server 50 and are operable to perform the functionality described herein when executed by the server 50. The search component 60 and the list manager 80 are in communication with one another, in that the search component 60 receives input from the list manager 80 and provides output to the list manager in response.

The list manager 80 is operable to receive the object information 34 that is transmitted to the server 50 from the connector application of the client 20. Based on the received object information 34, the list manager 80 formulates search queries and transmits the search queries to the search component 60. The search queries formulated and transmitted by the list manager 80 can be in any suitable form, structured or unstructured. As an example, the queries could be unstructured lists of one or more keywords. As another example, the queries could be structured queries including a keyword to be searched for each of one or more identified search fields, such as title, album, artist name, etc.

The search component 60 receives search queries from the list manager 80. The search component 60 utilizes the search queries that it receives from the list manager 80 to perform search queries based on the object information 34 that is received from the client 20 to determine whether one or more server side objects 72 that are disposed within the server side object store 70 correspond to the parameters specified by the object information 34. The search can be performed by the search component by comparing the parameters specified by the search queries to server side object information 74, which is metadata that describes the server side objects 72.

The server side objects 72 that are stored in the server side object store 70 of the server 50 are videos that include an audio component. When the search component 60 determines whether one of the server side objects 72 within the server side object store 70 is a matching video with respect to the music pieces stored as the client side objects 32, the search component can do so on the basis that the music title specified by the object information 34 corresponds to the music piece that is encoded as the audio component of the video that is stored as the server side object 72 within the server side object store 70. In order to allow identification of the server side object 72 by the search component 60, server side object information 74 can be stored within the server side object store 70, either within the server side objects 72 themselves or separate from the server side objects 72.

After the search component 60 executes the search queries, it provides search results to the list manager 80 in the form of an identification of one or more of server side objects 72 that are present within the server side object store 70. If the search results that are received from the search component 60 indicate that one or more of the server side objects 72 match the client side objects 32, as described by the object information 34, the list manager 80 adds the client side objects 32 that are identified as matching to a list 92 of matching objects. The list manager 80 then stores the list of matching objects in the list store 90.

The list 92 can be associated with a user account that is specified by the client 20. For example, the list store 90 can be a portion of a profile that is associated with the user account. By associating the list 92 with a user account, the list 92 can be accessed by the user, using the other devices 100. This allows the user to access the list 92 from a device other than the client 20 on which the client side objects 32 are stored.

The server 50 is operable to transmit the server side objects 72 in response to a playback request. Transmission of the server side objects 72 can be in the form of a streaming video transmission within a web page or web application. When the server 50 receives a playback request that is associated with the user account and which designates that list 92 of matching videos, the server 50 transmits one or more of the server side objects 72 that are specified by the list 92 in response to the playback request. For example, the playback request can be made by one of the other devices 100 that is associated with the user account, and the server side objects 72 are transmitted to the other device 100 in response to the playback request.

Additional related functionality can optionally be provided by the server 50. As an example, the list manager 80 can be configured to transmit a verification request to the client 20 in order to verify that the server side objects 72 that were identified as matching by the search component 60 actually correspond to the client side objects 32. The verification request is transmitted to the client 20 by the list manager 80 and identifies at least one of the objects of the list 92 of matching objects. The verification request can cause a prompt to be displayed by the client 20, which requests that the user provide input in the form of either a positive response, which indicates that the server side object 72 is a match to the client side object 32 or a negative response, which indicates that the server side object 72 is not a match to the client side object 32. The response is transmitted to the list manager 80 of the server 50 by the client. If a negative response is received, the list manager 80 removes the reference to the server side object 72 from the list 92.

The server 50 can be configured to allow the list 92 to be modified by the client 20. For example, the client 20 can transmit to the server 50 a request to modify the list 92 of matching objects. This request could be, for example, in the form of selection, by the user of the client 20, of a modification command that is present on a screen that is presented to a user of the client 20, such as in the form of a web page. The request to modify the list 92 includes an identification of one or more of the server side objects 72 that is to be added or deleted from the list 92. In response to the request, the list manager 80 modifies the list 92. The updated list 92 is then transmitted to the client 20.

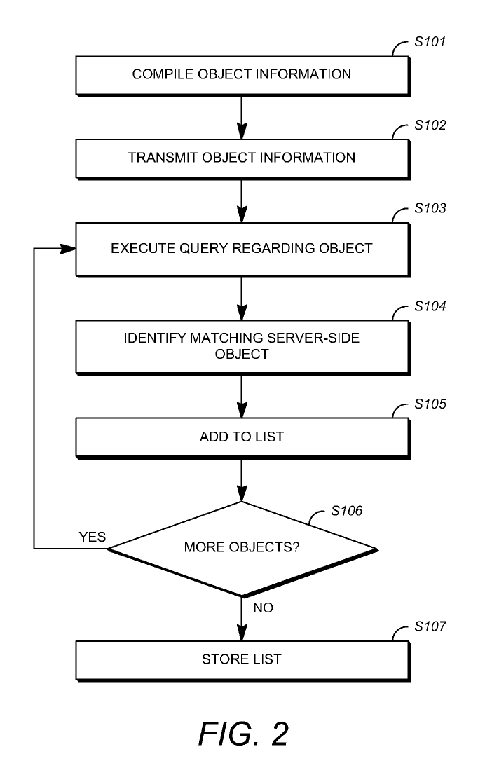

An example of a process for playing music on a video site will be explained with reference to FIG. 2.

In Step S101, the object information 34 is compiled by the connector application 40. The client 20 then transmits the object information 34 to the server 50 over the network 10 in Step S102, and the list manager 80 of the server 50 receives the object information 34. (In other embodiments, transmission can be initiated by list manager 80.) The list manager 80 formulates a query based on the object information 34 that was received from the client 20 and transmits the query to the search component 60. The search component 60 then executes the queries regarding the client side objects 32 in Step S103.

In Step S104, the search component 60 identifies one or more server side objects 72 and reports the results to the list manager 80, which adds an identification of the matching objects of the server side objects 72 to the list 92 in Step S105. In one embodiment, where multiple server side objects 72 are identified in response to a single query, the list manager 80 determines which matching server side object 72 to add to the list 92 (for example by random choice or by choosing an object that matches best). As one example, the list manager 80 determines which matching server side object 72 to use based at least in part on the identity of the user that uploaded the server side object 72 to the server 50. Certain users could be given status as an “official” or “preferred” uploader, based on quality of the content provided, a certification process, a licensing arrangement, or other circumstance, and this recognition would be given weight be the list manager 80 when selecting between multiple server side objects 72. As another example, the list manager 80 determines which matching server side object 72 to use based on the number of times that the server side object 72 has been viewed. In a further example the image resolution or other measure of quality of the server side object 72 is used by the list manager 80 as a basis for determining which server side object 72 to use. In another example, the preferences of other users, such as indications by other users that they like a particular object or ratings, are used by the list manager 80 as a basis for determining which server side object 72 to use. In other embodiments, list manager 80 accepts input from a user to choose which of multiple matching objects 72 to use.

In Step S105, it is determined whether the object information 34 that was received by the server 50 identifies additional client side objects 32 for which search queries must be performed by the search component 60. If there are additional client side objects 32 for which searches must be performed, Step S106 evaluates as “yes,” and the process returns to Step S103. If there are no more client side objects 32 that are identified by the object information 34 for which additional searches must be performed, Step S106 evaluates as “no,” and the process proceeds to Step S107. In Step S107, the completed list 92 is stored in the list store.

Completed list 92 is, thus, available for the user associated with the client. The user can access the video service to access a playlist of videos that have the same musical content as is stored on his client-side device. By playing the video playlist, the user can access his playlist when he is away from his client device. Some implementations also allow the user to manage his video playlist to change the order of the videos and to add or delete videos from the playlist. Some implementations also allow other users to access the user's playlist, either publicly or with permission of the user, or both.

Thus, for example, a user could use an implementation to create a playlist of videos that have the soundtrack of the songs stored on his personal music device. He could then play that playlist at a location where he did not have access to his personal music device.

Although the disclosure herein is made with reference to music pieces as the client side objects 32 and videos having an audio component as the server side objects 72, the invention can be applied in other contexts. For example, in alternative embodiments, the client side objects 32 and the server side objects 72 could be movies, ebooks, contacts, and other types of media or objects.

The client 20, the server 50, the other devices 100, and other elements of the systems discussed in this disclosure can be implemented in the form of one or more machines or devices capable of performing the described functions. These devices could be or include a processor, a computer, specialized hardware or any other device. The described functionality can be embodied in software instructions that are executable by the device or devices.

As used herein, the term “computer” means any device of any kind that is capable of processing a signal or other information. Examples of computers include, without limitation, an application-specific integrated circuit (ASIC) a programmable logic array (PLA), a microcontroller, a digital logic controller, a digital signal processor (DSP), a desktop computer, a laptop computer, a tablet computer, and a mobile device such as a mobile telephone. A computer does not necessarily include memory or a processor. A computer may include software in the form of programmable code, micro code, and or firmware or other hardware embedded logic. A computer may include multiple processors which operate in parallel. The processing performed by a computer may be distributed among multiple separate devices, and the term computer encompasses all such devices when configured to perform in accordance with the disclosed embodiments.

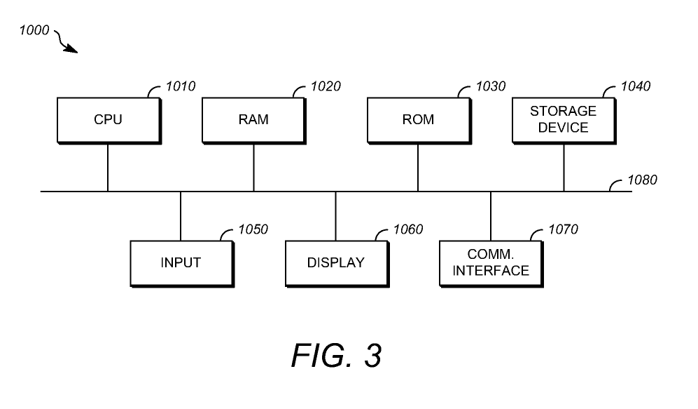

An example of a device that can be used as a basis for implementing the systems and functionality described herein is a conventional computer 1000, as shown in FIG. 3. The conventional computer 1000 can be any suitable conventional computer. As an example, the conventional computer 1000 includes a processor such as a central processing unit (CPU) 1010 and memory such as RAM 1020 and ROM 1030. A storage device 1040 can be provided in the form of any suitable computer readable medium, such as a hard disk drive. One or more input devices 1050, such as a keyboard and mouse, a touch screen interface, etc., allow user input to be provided to the CPU 1010. A display 1060, such as a liquid crystal display (LCD) or a cathode-ray tube (CRT), allows output to be presented to the user. A communications interface 1070 is any manner of wired or wireless means of communication that is operable to send and receive data or other signals using the network 10. The CPU 1010, the RAM 1020, the ROM 1030, the storage device 1040, the input devices 1050, the display 1060 and the communications interface 1070 are all connected to one another by a bus 1080.

The client 20, the server 50, the other devices 100, and other elements of the systems discussed in this disclosure can be implemented in the form of a single system or in the form of separate systems. Moreover, each of the client 20, the server 50, the other devices 100, and other elements of the systems discussed in this disclosure can be implemented in the form of multiple computers, processors, or other systems working in concert. As an example, the functions of the server 50 can be distributed among a plurality of conventional computers, such as the computer 1000, each of which are capable of performing some or all of the functions of the server 50.

As previously noted, components of the systems described herein can be connected for communications with one another by networks such as the network 10. The communications functions described herein can be accomplished using any kind of network or communications means capable of transmitting data or signals. Suitable examples include the internet, which is a packet-switched network, a local area network (LAN), wide area network (WAN), virtual private network (VPN), or any other means of transferring data. A single network or multiple networks that are connected to one another can be used. It is specifically contemplated that multiple networks of varying types can be connected together and utilized to facilitate the communications contemplated by the systems and elements described in this disclosure.

While this disclosure includes what is presently considered to be the most practical and preferred embodiment, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method performed by one or more server computers, comprising:
receiving, from a client, a plurality of music titles for respective music pieces that a user has the right to listen to;
determining, for one of the plurality of music titles, that a matching video stored on the server has the respective music piece for the music title as an audio component of the matching video;
adding the matching video to a list of matching videos; and
storing the list of matching videos on the one or more server computers so that it is accessible to a user associated with the client.

2. The method of claim 1, wherein the respective music pieces that the user has the right to listen to correspond to media files that are stored on the client.

3. The method of claim 1, wherein the respective music pieces that the user has the right to listen to correspond to content licenses associated with the client.

4. The method of claim 1, further comprising:
associating the list of matching videos with a user account specified by the client.

5. The method of claim 4, further comprising:
receiving a playback request that is associated with the user account; and
transmitting one or more matching videos specified by the list of matching videos in response to the playback request.

6. The method of claim 5, wherein the playback request originates from a device that is separate from the client and the one or more matching videos are transmitted to the device.

7. The method of claim 1, further comprising:
receiving, from the client, a request to modify the list of matching videos;
modifying the matching videos to produce an updated list of matching videos in response to the request to modify the list of matching videos; and
storing the updated list of matching videos on the one or more server computers so that it is accessible to a user associated with the client.

8. The method of claim 1, further comprising:
sending, to the client, a verification request that identifies at least one video of the list of matching videos; and
removing the at least one video identified by the verification request from the list of matching videos if a negative response is received in response to the verification request.

9. A video server including one or more server computers, comprising:
an object store containing a plurality of videos each having an audio component;
a search component that receives, from a client, a plurality of music titles for respective music pieces that a user has the right to listen to and determines, for one of the plurality of music titles, that a matching video of the plurality of videos in the object store has the respective music piece for the music title as an audio component of the matching video; and
a list manager that adds the matching video to a list of matching videos and stores the list of matching videos on the one or more server computers so that it is accessible to a user associated with the client.

10. The video server of claim 9, wherein the respective music pieces correspond to media files that are stored on the client.

11. The video server of claim 9, wherein the respective music pieces correspond to content licenses that are associated with the client.

12. The video server of claim 9, further comprising:
a list store, wherein the list manager associates the list of matching videos with a user account specified by the client, and stores the list of matching videos in the list store.

13. The video server of claim 12, wherein the list manager is operable to receive a playback request that is associated with the user account, retrieve the list of matching videos from the list store based on the user account, and transmit the one or more matching videos specified by the list of matching videos in response to the playback request.

14. The video server of claim 13, wherein the playback request originates from a device that is separate from the client, and the one or more matching videos are transmitted to the device.

15. The video server of claim 9, wherein the list manager modifies the list of matching videos to produce an updated list of matching videos in response to a request, from the client, to modify the list of matching videos, and stores the updated list of matching videos on the one or more server computers so that it is accessible to a user associated with the client.

16. The video server of claim 9, wherein the list manager sends, to the client, a verification request that identifies at least one video of the list of matching videos, and removes the at least one video identified by the verification request from the list of matching videos if a negative response is received in response to the verification request.

17. A video server including one or more server computers, comprising:
an object store containing a plurality of videos each having an audio component;
a list store;
a search component that receives, from a client, a plurality of music titles for respective music pieces that a user has the right to listen to and determines, for one of the plurality of music titles, that a matching video of the plurality of videos in the object store has the respective music piece for the music title as an audio component of the matching video; and
a list manager that adds the matching video to a list of matching videos, associates the list of matching videos with a user account specified by the client, and stores the list of matching videos in the list store so that it is accessible to a user associated with the user account.

18. The video server of claim 17, wherein the list manager sends the list of matching videos to the client.

19. The video server of claim 18, wherein the list manager modifies the list of matching videos to produce an updated list of matching videos in response to a request, from the client, to modify the list of matching videos, and sends the updated list of matching videos to the client.

20. The video server of claim 17, wherein the list manager is operable to receive a playback request that is associated with the user account, retrieve the list of matching videos from the list store based on the user account, and transmits the one or more matching videos specified by the list of matching videos in response to the playback request.

21. The video server of claim 20, wherein the playback request originates from a device that is separate from the client and the one or more matching videos are transmitted to the device.

22. The video server of claim 17, wherein the list manager sends, to the client, a verification request that identifies at least one video of the list of matching videos, and removes the at least one video identified by the verification request from the list of matching videos if a negative response is received in response to the verification request.
